(19) United States
(12) Patent Application Publication
(10) Pub. No.: US 2026/0032061 A1
(43) Pub. Date: Jan. 29, 2026

(54) SYSTEMS AND METHODS FOR INTERFACE BETWEEN TIME-SENSITIVE NETWORKING SYSTEM AND ANALYTICS FUNCTION OF WIRELESS CORE NETWORK

(71) Applicant: Verizon Patent and Licensing Inc., Basking Ridge, NJ (US)

(72) Inventors: Vijayakrishna P. Guduru, Denville, NJ (US); Andrew E. Youtz, Princeton, NJ (US); Jeremy Nacer, Boca Raton, FL (US); Sudhakar Reddy Patil, Flower Mound, TX (US)

(73) Assignee: Verizon Patent and Licensing Inc., Basking Ridge, NJ (US)

(21) Appl. No.: 18/783,564

(22) Filed: Jul. 25, 2024

(51) Int. Cl. H04L 41/5009; H04L 41/16; H04W 24/02

(52) U.S. Cl. CPC H04L 41/5009; H04L 41/16; H04W 24/02

(57) ABSTRACT

A system may determine that a particular communication session, between a User Equipment (“UE”) and a wireless network, is associated with a set of time-sensitive communication policies; output a first indication, to one or more Network Functions (“NFs”) of the wireless network with which the particular communication session is associated, that the particular communication session is associated with the set of time-sensitive communication policies; output a second indication, to one or more routing devices via which the one or more NFs communicate, that the particular communication session is associated with the set of time-sensitive communication policies; receive, from the one or more NFs, a first set of Key Performance Indicators (“KPIs”) associated with the time-sensitive communication session; receive, from the routing devices, a second set of KPIs associated with the time-sensitive communication session; and output the first and second sets of KPIs to an analytics element of the wireless network.

### BACKGROUND

Wireless networks provide wireless connectivity to User Equipment (“UEs”), such as mobile telephones, tablets, Internet of Things (“IoT”) devices, Machine-to-Machine (“M2M”) devices, industrial sensors, Automated Guided Vehicles (“AGVs”), Automated Mobile Robots (“AMRs”), Fixed wireless Access (“FWA”) devices, or the like. Some services provided via wireless networks may have time-sensitivity requirements or other types of Quality of Service (“QoS”) requirements. For example, mission-critical services, AGV control services, industrial sensor monitoring services, AMR control services, gaming services, or other types of services may have such requirements.

### BRIEF DESCRIPTION OF THE DRAWINGS

FIG. 1 illustrates an example overview of one or more embodiments described herein;

FIGS. 2A and 2B illustrate example interfaces provided by one or more embodiments described herein;

FIG. 3 illustrates an example of time-sensitive communication analytics reporting in conjunction with a time synchronization service, in accordance with some embodiments;

FIG. 4 illustrates an example process for providing analytics reporting for time-sensitive communication sessions in a wireless network, in accordance with some embodiments;

FIGS. 5 and 6 illustrate example environments in which one or more embodiments, described herein, may be implemented;

FIG. 7 illustrates an example arrangement of a radio access network (“RAN”), in accordance with some embodiments; and

FIG. 8 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

A wireless network may include network functions (“NFs”) that perform various operations with respect to providing services via the network, and may also include one or more routing devices that facilitate communications between the NFs of the wireless network in order to facilitate the operations performed by such NFs. The NFs and/or the routing devices of the wireless network may include configurable parameters via which different QoS parameters, Service Level Agreements (“SLAs”), etc. may be provided on a per-communication session basis, a per-UE basis, a per-network slice basis, or on some other basis. Such QoS parameters, SLAs, etc. may be associated with time-sensitive communications, such as communications associated with policies indicating maximum latency thresholds or other suitable policies.

For example, in some implementations, the wireless network may include, may be communicatively coupled to, or may otherwise be associated with a Time-Sensitive Networking (“TSN”) system. In some implementations, the TSN may include a Centralized User Configuration (“CUC”) and/or a Centralized Network Configuration (“CNC”), which perform operations including configuring NFs and/or routing devices of the wireless network to implement parameters in order to meet QoS parameters, SLAs, etc. associated with particular time-sensitive communications provided via the wireless network. For example, as discussed below, the CUC may communicate with NFs of the wireless network, such as an Access and Mobility Management Function (“AMF”), a Session Management Function (“SMF”), and/or other NFs, in order to implement configuration parameters such as queuing parameters, weighting parameters, priority parameters, or the like, for time-sensitive communications (e.g., in order to meet latency thresholds or other policies associated with the time-sensitive communications). Similarly, the CNC may communicate with routing devices of the wireless network (e.g., routing devices that facilitate communications between NFs that handle particular time-sensitive communications) in order to implement configuration parameters (e.g., routing paths, routing device selection, etc.) for time-sensitive communications.

Embodiments herein provide for network analytics, associated with time-sensitive communications, to be reported to and aggregated by a network analytics function of a wireless network, such as a Network Data Analytics Function (“NWDAF”). For example, as discussed below, an interface may be provided between a CUC and an NWDAF, such that the NWDAF is able to receive, monitor, etc. analytics related to time-sensitive communications, such as time-sensitive communication configuration parameters provided to NFs and/or routing devices of the wireless network, operational parameters of NFs and/or routing devices that handle time-sensitive communications (e.g., queue or buffer status, QoS parameters, or the like), performance metrics (e.g., latency, throughput, etc.), Key Performance Indicators (“KPIs”), and/or other information associated with time-sensitive communications handled by such NFs and/or routing devices of the wireless network. The NWDAF and/or some other suitable device or system may utilize the analytics associated with time-sensitive communications, potentially in conjunction with other analytics received or aggregated by the NWDAF (e.g., configuration parameters, KPIs, etc. associated with other elements of the wireless network), in order to improve or refine the operation of the network. Such improvements or refinements may include generating or modifying policies, QoS parameters, artificial intelligence/machine learning (“AI/ML”) models, or other suitable operations.

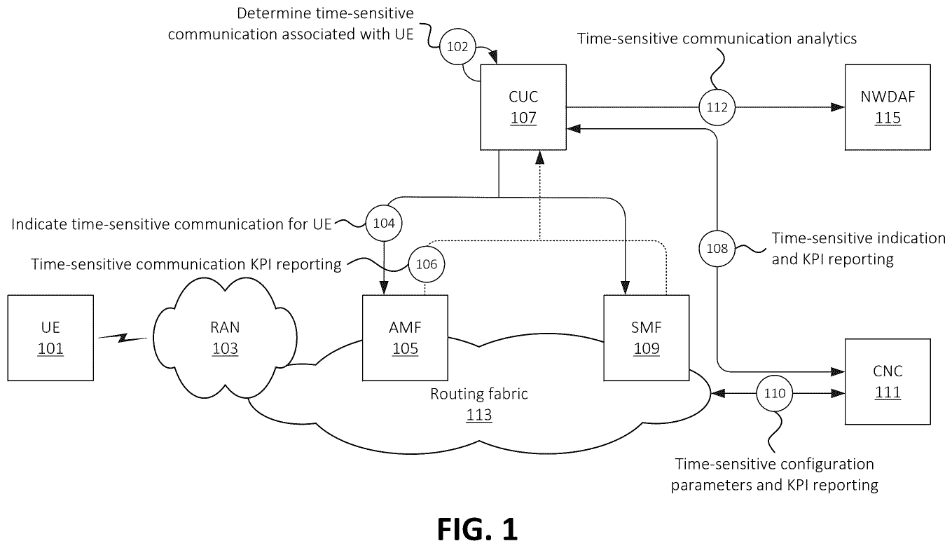

FIG. 1 illustrates an example overview of some embodiments. As shown, a particular UE 101 may be wirelessly connected to a particular RAN 103 of a wireless network. For example, RAN 103 may include wireless network infrastructure equipment such as one or more base stations (e.g., an evolved Node B (“eNB”), a Next Generation Node B (“gNB”), etc.) that implement one or more radio access technologies (“RATs”), such as a Long-Term Evolution (“LTE”) RAT, a Fifth Generation (“5G”) RAT, etc. RAN 103 may be communicatively coupled to Access and Mobility Management Function (“AMF”) 105, which may perform operations related to managing access of UE 101 to RAN 103, mobility-related operations associated with UE 101, and/or other suitable operations. AMF 105 may also provide RAN configuration parameters to RAN 103, such as QoS parameters associated with UE 101, priority parameters associated with UE 101, or the like.

As further shown, the wireless network may include, may be communicatively coupled to, and/or may otherwise be associated with CUC 107. For example, in some implementations, CUC 107 may be co-located with, communicatively coupled to, implemented by, etc. a particular SMF 109 and/or some other NF of the wireless network. As discussed in more detail below, CUC 107 may perform functionality related to facilitating time-sensitive communications between UE 101 (and/or other devices) via the wireless network, where such functionality may include configuring NFs of the wireless network based on latency thresholds or other suitable policies associated with time-sensitive communications.

The wireless network may further include, may be communicatively coupled to, and/or may otherwise be associated with CNC 111. For example, in some implementations, CNC 111 may be co-located with, communicatively coupled to, implemented by, etc. one or more routing devices of the wireless network, a routing controller of wireless network, or the like. As discussed in more detail below, CNC 111 may perform functionality related to facilitating time-sensitive communications between UE 101 (and/or other devices) via the wireless network, where such functionality may include configuring routing devices of the wireless network based on latency thresholds or other suitable policies associated with time-sensitive communications. Such routing devices, routing controllers, etc. are referred to herein as routing fabric 113.

As shown, CUC 107 may at some point determine (at 102) a time-sensitive communication associated with UE 101. For example, UE 101 may have requested the establishment of a communication session (e.g., a protocol data unit (“PDU”) session), where such request includes a time-sensitive communication indicator, flag, value, etc. As another example, a UE information repository of the wireless network (e.g., a Unified Data Management function (“UDM”), a Unified Data Repository (“UDR”), a Home Subscriber Server (“HSS”), etc.) and/or a policy element of the wireless network (e.g., a Policy Control Function (“PCF”), a Policy Charging and Rules Function (“PCRF”), etc.) may maintain information, policies, etc. indicating that one or more communication sessions associated with UE 101 are associated with time-sensitive communications (e.g., are associated with particular latency thresholds or other parameters or policies). In some embodiments, CUC 107 may receive an indication, a notification, etc. from SMF 109 that UE 101 is associated with one or more time-sensitive communications.

In some embodiments, determining the time-sensitive communication associated with UE 101 may include identifying one or more identifiers of UE 101, such as a Subscription Permanent Identifier (“SUPI”), a Globally Unique Temporary Identifier (“GUTI”), an Mobile Directory Number (“MDN”), an International Mobile Station Equipment Identity (“IMEI”), an International Mobile Subscriber Identity (“IMSI”), or the like. In some embodiments, determining the time-sensitive communication associated with UE 101 may include identifying one or more particular communication sessions (e.g., PDU session identifiers) with which the time-sensitive communication is associated. In some situations, one or more communication sessions (e.g., a first set of PDU sessions) associated with UE 101 may be associated with time-sensitive communications, while one or more other communication sessions (e.g., a second set of PDU sessions) associated with the same UE 101 may not be associated with time-sensitive communications. In some embodiments, determining that UE 101 is associated with one or more time-sensitive communications may include identifying particular policies or parameters of the time-sensitive communications, such as one or more latency thresholds.

As noted above, CUC 107 may indicate (at 104), to one or more NFs of the wireless network, that UE 101 (and/or one or more particular communication sessions associated with UE 101) are associated with a time-sensitive communication. For example, CUC 107 may provide one or more UE identifiers, one or more PDU session identifiers, etc. to AMF 105, SMF 109, and/or one or more other NFs of the wireless network. In some embodiments, CUC 107 may be communicatively coupled to one or more NFs of the wireless network via a Network Exposure Function (“NEF”), a Service Capability Exposure Function (“SCEF”), and/or some other suitable device or system. Additionally, or alternatively, as noted above, functionality of CUC 107 may be implemented by one or more elements of the wireless network (e.g., SMF 109), which may communicate with other NFs of the wireless network via existing interfaces or communication pathways.

In some embodiments, CUC 107 may identify particular NFs of the wireless network that are associated with UE 101 (and/or are associated with one or more time-sensitive communication sessions associated with UE 101) by querying one or more other NFs, such as a Network Repository Function (“NRF”). For example, when outputting (at 104) a time-sensitive communication indication to AMF 105, CUC 107 may identify a particular AMF 105 that has been assigned to manage, handle, etc. UE 101, and may output the time-sensitive communication indication to such particular AMF 105.

In some embodiments, outputting (at 104) the time-sensitive communication indication to the NFs of the wireless network (e.g., NFs with which the time-sensitive communication is associated, such as NFs that are assigned to handle, process, etc. a time-sensitive communication session associated with UE 101) may include outputting a subscription indication for certain types of information which may be pertinent to the time-sensitive communication policies with which the time-sensitive communication session is associated. For example, CUC 107 may output a subscription notification to AMF 105, SMF 109, and/or other NFs, for information such as buffer status, priority information associated with UE 101, and/or other suitable information.

CUC 107 may also provide a time-sensitive communication indication to such NFs, and/or may otherwise provide information associated with the time-sensitive communication (e.g., maximum latency policies and/or other policies). Although FIG. 1 only shows AMF 105 and SMF 109 as receiving the time-sensitive communication information from CUC 107, in practice, one or more other NFs may receive such information from CUC 107 and/or from one or more other NFs. The NFs receiving (at 104) the time-sensitive communication information may implement one or more configuration parameters based on the time-sensitive communication information, such as prioritizing traffic associated with UE 101, prioritizing traffic associated with one or more time-sensitive communication sessions associated with UE 101, etc. For example, AMF 105 may configure RAN 103 to prioritize time-sensitive communications associated with UE 101, and SMF 109 may configure one or more user plane elements of the wireless network (e.g., a User Plane Function (“UPF”)) to prioritize time-sensitive communications associated with UE 101.

The NFs of the wireless network (e.g., AMF 105, SMF 109, and/or one or more other NFs) may, in accordance with some embodiments, report (at 106) KPIs, metrics, configuration parameters, acknowledgements, and/or other suitable information to CUC 107. Generally, such information may be related to the implementation of time-sensitive communications with respect to UE 101. For example, such information may include buffer status information, prioritization policies with respect to UE 101 and/or communication sessions associated with UE 101, QoS parameters, alerts, or the like. In this sense, CUC 107 may be “aware” of configurations, KPIs, etc. associated with the NFs of the wireless network, which facilitate time-sensitive communications for UE 101. In some embodiments, the NFs of the wireless network may output the information to CUC 107 based on a subscription to such information by CUC 107, as discussed above. In some embodiments, CUC 107 may request, or “pull” the information from the NFs on a periodic basis or some other ongoing basis.

CUC 107 may further, based on determining the time-sensitive communication associated with UE 101, provide (at 108) a time-sensitive communication indication, associated with UE 101 and/or one or more communication sessions associated with UE 101, to CNC 111. CNC 111 may communicate (at 110) with one or more elements of routing fabric 113 (e.g., one or more routing devices, one or more routing controllers, etc.) in order to instruct such elements of routing fabric 113 to implement one or more configurations to facilitate the time-sensitive communication associated with UE 101 (e.g., to meet latency thresholds and/or to satisfy other policies associated with the indicated time-sensitive communication).

CNC 111 may further monitor and/or otherwise receive KPIs, metrics, configuration information, or the like from routing fabric 113. Such information may include, for example, acknowledgements from one or more elements of routing fabric 113 that the time-sensitive communication indication was received from CNC 111, routing paths configured for UE 101 and/or the time-sensitive communication associated with UE 101, buffer status of one or more routing devices of routing fabric 113, and/or other suitable information. In this sense, CNC 111 may be “aware” of configurations, KPIs, etc. associated with routing devices of routing fabric 113 (e.g., routing devices that implement links between NFs and/or RAN 103 of the wireless network), which facilitate time-sensitive communications for UE 101.

CNC 111 may further provide (at 108) some or all of the received information to CUC 107. In this manner, CUC 107 may maintain a “holistic view” of wireless network with respect to the implementation of time-sensitive communications for UE 101. CUC 107 may further provide (at 112) some or all of the received (at 106 and 108) time-sensitive communication monitoring information to NWDAF 115.

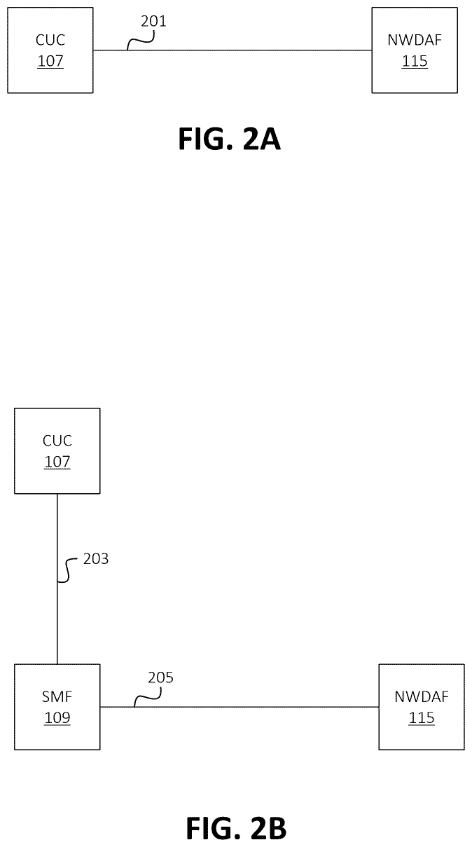

As shown in FIG. 2A, some embodiments provide a dedicated interface 201 between CUC 107 and NWDAF 115, via which CUC 107 and NWDAF 115 may communicate. For example, via interface 201, NWDAF 115 may subscribe to updates, from CUC 107, for information associated with a particular UE 101 and/or a particular time-sensitive communication session (e.g., a particular PDU session that is associated with time-sensitive communications). For example, based on the subscription, CUC 107 may proactively notify or “push” time-sensitive communication information, such as configuration information, KPIs, etc. to NWDAF 115 when such information is received or determined by CUC 107. As another example, NWDAF 115 may output requests for information associated with a particular UE 101 and/or a particular time-sensitive communication session to CUC 107 via interface 201, and CUC 107 may respond to such requests with the requested time-sensitive communication information.

Subscribing to the information from CUC 107 may include sending one or more particular types of messages to CUC 107. For example, NWDAF 117 may output an EventExposure_Subscribe message to CUC 107 (e.g., where such message includes an indication or identifier of the particular UE 101 and/or the particular time-sensitive communication), based on which CUC 107 may determine that NWDAF 117 is subscribed to information associated with the particular UE 101 and/or the particular time-sensitive communication session. In some embodiments, NWDAF 117 may request (e.g., periodically and/or on some other basis) information associated with a particular UE 101 and/or a particular time-sensitive communication session from CUC 107, such as an EventExposure_Request message. In some embodiments, NWDAF 117 may end a subscription to information from CUC 107 regarding a particular UE 101 and/or time-sensitive communication session via an EventExposure_Unsubscribe message or other suitable message.

In some embodiments, as shown in FIG. 2B, CUC 107 may indirectly communicate with NWDAF 115 via one or more other NFs of the wireless network. For example, in some embodiments, CUC 107 may communicate with SMF 109 via interface 203. Additionally, or alternatively, SMF 109 may implement some or all of the functionality described above with respect to CUC 107, and/or SMF 109 and CUC 107 may be implemented by the same device or system. In such embodiments, communications described herein between CUC 107 and NWDAF 115 may include communications that are provided by CUC 107 to SMF 109 via interface 203 and then by SMF 109 to NWDAF 115 via interface 205, and/or communications that are provided by NWDAF 115 to SMF 109 via 205 and then by SMF 109 to CUC 107 via interface 203.

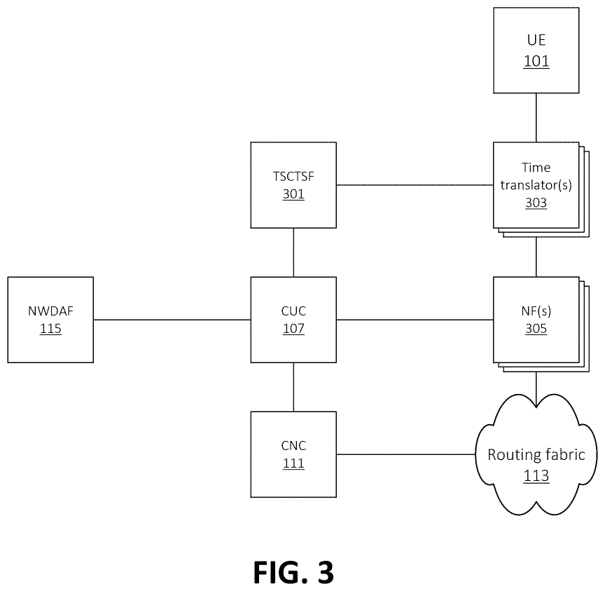

In some embodiments, some or all of the above-described techniques may augment, enhance, and/or otherwise be used with other services or applications, such as time synchronization services provided via the wireless network. For example, as shown in FIG. 3, Time-Sensitive Communication Time Synchronization Function (“TSCTSF”) 301 may be communicatively coupled to one or more time translators 303. TSCTSF 301 may, for example, communicate with time translators 303 to coordinate time synchronization techniques such that time translators 303 and TSCTSF 301 maintain the same precise time, which may be used in applications such as AGV guidance, mission critical communications, or the like.

In some implementations, one or more time translators 303 (e.g., network-side time translators (“NW-TTs”)) may be implemented by, communicatively coupled to, and/or otherwise associated with one or more NFs 305 of the wireless network, such as a UPF with which a given UE 101 communicates. In some embodiments, one or more time translators 303 may be communicatively coupled to one or more respective NFs 305 via a NEF, a SCEF, or some other suitable device or system. Additionally, or alternatively, the same device or system that implements a given NF 305 may also implement a respective time translator 303.

Similarly, one or more time translators 303 (e.g., device-side time translators (“DS-TTs”)) may be implemented by, communicatively coupled to, and/or otherwise associated with one or more UEs 101. As such, NFs 305 as well as UEs 101 that implement, are communicatively coupled to, and/or are otherwise associated with time translators 303 may operate according to a time synchronization service provided by TSCTSF 301 and time translators 303.

In some embodiments, TSCTSF 301 may be communicatively coupled to CUC 107, which may indicate particular UEs 101, communication sessions, etc. that are associated with time synchronization techniques implemented by TSCTSF 301 (e.g., in conjunction with time translators 303). In some embodiments, TSCTSF 301 may provide policies, thresholds, etc. associated with such techniques (e.g., latency thresholds or other suitable policies).

As similarly noted above, CUC 107 may communicate with NFs 305 and/or CNC 111 (which in turn communicates with routing fabric 113 via which such NFs 305 communicate) in order to configure elements of the wireless network to implement the policies, thresholds, etc. associated with the time synchronization techniques as indicated by TSCTSF 301. As also noted above, CUC 107 may provide KPIs, metrics, configuration information, alerts, etc. to NWDAF 115, where such information is related to the configuration of NFs 305 and/or routing fabric 113 to implement the time synchronization services indicated by TSCTSF 301. Further, in some embodiments, CUC 107 may provide, to NWDAF 115, analytics information received from TSCTSF 301, such as an indication of particular time synchronization services indicated by TSCTSF 301, identifiers of NFs 305 that are communicatively coupled to respective time translators 303 (e.g., respective NW-TTs), identifiers of UEs 101 that are communicatively coupled to respective time translators 303 (e.g., respective DS-TTs), status or configuration information associated with time translators 303, and/or other suitable information associated with the time synchronization service. In this manner, NWDAF 115 may aggregate information associated with time-sensitive communications implemented by the wireless network as well as information associated with techniques that utilize such time-sensitive communications (e.g., time synchronization services), in order to more holistically optimize the operation of the wireless network as well as the operation of services that operate in conjunction with time-sensitive communication functionality provided by the wireless network (e.g., provided by CUC 107 and/or CNC 111).

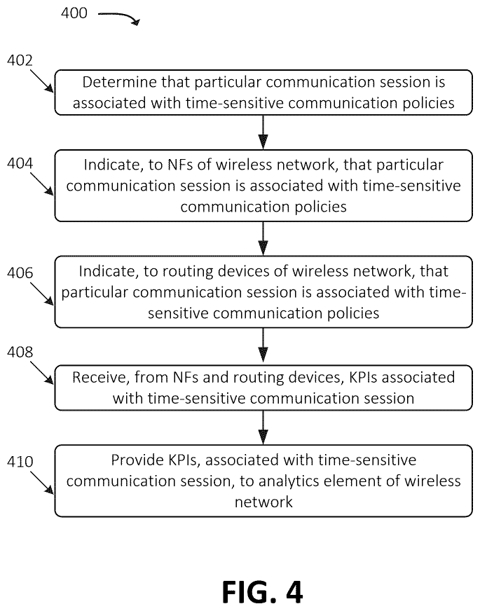

FIG. 4 illustrates an example process 400 for providing analytics reporting for time-sensitive communication sessions in a wireless network. In some embodiments, some or all of process 400 may be performed by CUC 107. In some embodiments, one or more other devices may perform some or all of process 400 in concert with CUC 107, such as CNC 111.

As shown, process 400 may include determining (at 402) that a particular communication session is associated with time-sensitive communication policies. For example, as discussed above, CUC 107 may determine that a particular communication session (e.g., PDU session) is associated with one or more time-sensitive communication policies. As discussed above, such determination may be based on attributes of a particular UE 101 with which the communication session is associated and/or other suitable factors. In some embodiments, one or more other devices, such as SMF 109 and/or TSCTSF 301, may indicate to CUC 107 that the particular communication session is associated with the time-sensitive communication policies. As discussed above, the time-sensitive communication policies may include maximum latency thresholds, SLAs, or other suitable policies. CUC 107 may determine one or more identifiers of the particular communication session (e.g., a PDU session identifier), and/or may determine one or more identifiers of the particular UE 101 with which the particular communication session is associated.

Process 400 may further include indicating (at 404), to one or more NFs of the wireless network, that the particular communication session is associated with the time-sensitive communication policies. For example, in some embodiments, CUC 107 may identify particular NFs 305 that have been assigned to handle, process, etc. the time-sensitive communication session, and may provide an indication of the time-sensitive communication policies with which the time-sensitive communication session is associated, and may notify such NFs 305 of the time-sensitive communication policies with which the time-sensitive communication session is associated. As discussed above, NFs 305 may modify configuration information based on the indication, such as setting priority levels, weights, etc. associated with time-sensitive communication session in order to meet the indicated time-sensitive communication policies.

Process 400 may additionally include indicating (at 406), to routing devices of the wireless network, that the particular communication session is associated with the time-sensitive communication policies. For example, as discussed above, CUC 107 may notify CNC 111 of the time-sensitive communication policies associated with the time-sensitive communication session. CNC 111 may configure routing fabric 113, and/or may communicate with one or more controllers of routing fabric 113, in order to modify configuration information of one or more routing devices of routing fabric 113 in order to meet the indicated time-sensitive communication policies.

Process 400 may also include receiving (at 408), from the NFs and routing devices, KPIs associated with the time-sensitive communication session. For example, as discussed above, CUC 107 may subscribe to updates associated with the time-sensitive communication session, may request (e.g., periodically or on some other basis) KPIs associated with the time-sensitive communication session from NFs 305, etc. Additionally, CUC 107 may receive KPIs, metrics, configuration information, etc. associated with routing fabric (e.g., from CNC 111).

Process 400 may further include providing (at 410) the KPIs, associated with the time-sensitive communication session, to an analytics element of the wireless network. For example, CUC 107 may provide the KPIs, received from NFs 305 and routing fabric 113 (e.g., via CNC 111), to NWDAF 115. NWDAF 115 may, for example, have subscribed to such information (e.g., information associated with the particular UE 101, information associated with the particular time-sensitive communication session, information associated with the particular time-sensitive communication policies with which the particular time-sensitive communication session is associated, etc.). CUC 107 may accordingly provide (e.g., “push”) the information to NWDAF 115 based on the subscribing. NWDAF 115 may aggregate the KPIs associated with the particular time-sensitive communication session in order to identify analytics associated with the particular time-sensitive communication session. Such analytics may be used to identify, for example, whether the time-sensitive communication policies are being met, how many resources are being used to implement the time-sensitive communication session, and/or other suitable information. Further, NWDAF 115 may receive analytics information from other sources, and/or analytics information pertaining to other types of communication sessions or services, in order to gain a holistic view of the network. In some implementations, other NFs may send analytics request to NWDAF 115 (e.g., an AnalyticsSubscription_Subscribe message, an AnalyticsInfo_Request, etc.) in order to receive analytics information collected by NWDAF 115 (e.g., information regarding time-sensitive communications, as discussed above). NWDAF 115 and/or some other suitable device or system may modify the configuration of the network (e.g., of NFs 305 and/or routing fabric 113) based on such analytics information. In some embodiments, NWDAF 115 and/or some other suitable device or system may utilize AI/ML techniques (e.g., one or more AI/ML models) to modify the configuration of the network based on the analytics information received from CUC 107.

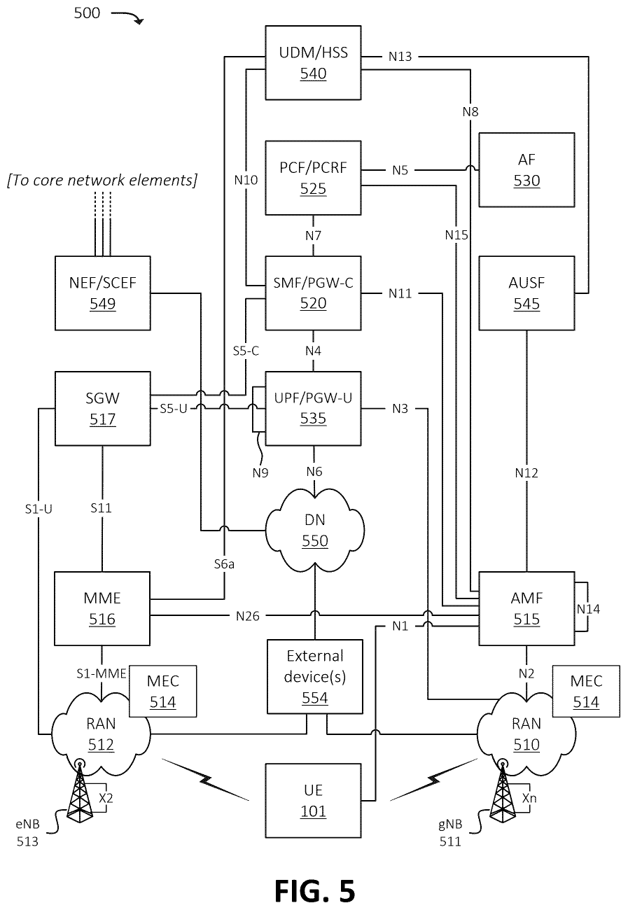

FIG. 5 illustrates an example environment 500, in which one or more embodiments may be implemented. In some embodiments, environment 500 may correspond to a 5G network, and/or may include elements of a 5G network. In some embodiments, environment 500 may correspond to a 5G Non-Standalone (“NSA”) architecture, in which a 5G RAT may be used in conjunction with one or more other RATs (e.g., an LTE) RAT), and/or in which elements of a 5G core network may be implemented by, may be communicatively coupled with, and/or may include elements of another type of core network (e.g., an evolved packet core (“EPC”)). In some embodiments, portions of environment 500 may represent or may include a 5G core (“5GC”). As shown, environment 500 may include UE 101, RAN 510 (which may include one or more gNBs 511), RAN 512 (which may include one or more eNBs 513), and various network functions such as AMF 515, Mobility Management Entity (“MME”) 516, Serving Gateway (“SGW”) 517, SMF/Packet Data Network (“PDN”) Gateway (“PGW”)-Control plane function (“PGW-C”) 520, PCF/PCRF 525, Application Function (“AF”) 530, UPF/PGW-User plane function (“PGW-U”) 535, UDM/HSS 540, Authentication Server Function (“AUSF”) 545, and NEF/SCEF 549. Environment 500 may also include one or more networks, such as Data Network (“DN”) 550. Environment 500 may include one or more additional devices or systems communicatively coupled to one or more networks (e.g., DN 550), such as one or more external devices 554.

The example shown in FIG. 5 illustrates one instance of each network component or function (e.g., one instance of SMF/PGW-C 520, PCF/PCRF 525, UPF/PGW-U 535, UDM/HSS 540, and/or AUSF 545). In practice, environment 500 may include multiple instances of such components or functions. For example, in some embodiments, environment 500 may include multiple “slices” of a core network, where each slice includes a discrete and/or logical set of network functions (e.g., one slice may include a first instance of AMF 515, SMF/PGW-C 520, PCF/PCRF 525, and/or UPF/PGW-U 535, while another slice may include a second instance of AMF 515, SMF/PGW-C 520, PCF/PCRF 525, and/or UPF/PGW-U 535). The different slices may provide differentiated levels of service, such as service in accordance with different QoS parameters.

The quantity of devices and/or networks, illustrated in FIG. 5, is provided for explanatory purposes only. In practice, environment 500 may include additional devices and/or networks, fewer devices and/or networks, different devices and/or networks, or differently arranged devices and/or networks than illustrated in FIG. 5. For example, while not shown, environment 500 may include devices that facilitate or enable communication between various components shown in environment 500, such as routers, modems, gateways, switches, hubs, etc. (e.g., routing fabric 113). In some implementations, one or more devices of environment 500 may be physically integrated in, and/or may be physically attached to, one or more other devices of environment 500. Alternatively, or additionally, one or more of the devices of environment 500 may perform one or more network functions described as being performed by another one or more of the devices of environment 500.

Additionally, one or more elements of environment 500 may be implemented in a virtualized and/or containerized manner. For example, one or more of the elements of environment 500 may be implemented by one or more Virtualized Network Functions (“VNFs”), Cloud-Native Network Functions (“CNFs”), etc. In such embodiments, environment 500 may include, may implement, and/or may be communicatively coupled to an orchestration platform that provisions hardware resources, installs containers or applications, performs load balancing, and/or otherwise manages the deployment of such elements of environment 500. In some embodiments, such orchestration and/or management of such elements of environment 500 may be performed by, or in conjunction with, the open-source Kubernetes® application programming interface (“API”) or some other suitable virtualization, containerization, and/or orchestration system.

Elements of environment 500 may interconnect with each other and/or other devices via wired connections, wireless connections, or a combination of wired and wireless connections. Examples of interfaces or communication pathways between the elements of environment 500, as shown in FIG. 5, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 5, such as Service-Based Interfaces (“SBIs”), including an Namf interface, an Nudm interface, an Npcf interface, an Nupf interface, an Nnef interface, an Nsmf interface, and/or one or more other SBIs.

UE 101 may include a computation and communication device, such as a wireless mobile communication device that is capable of communicating with RAN 510, RAN 512, and/or DN 550. UE 101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, a wearable device, a programmable logic controller or other industrial controller, an M2M device, or the like), a FWA device, or another type of mobile computation and communication device. UE 101 may send traffic to and/or receive traffic (e.g., user plane traffic) from DN 550 via RAN 510, RAN 512, and/or UPF/PGW-U 535.

RAN 510 may be, or may include, a 5G RAN that implements a 5G RAT and that includes one or more base stations (e.g., one or more gNBs 511), via which UE 101 may communicate with one or more other elements of environment 500. UE 101 may communicate with RAN 510 via an air interface (e.g., as provided by gNB 511). For instance, RAN 510 may receive traffic (e.g., user plane traffic such as voice call traffic, data traffic, messaging traffic, etc.) from UE 101 via the air interface, and may communicate the traffic to UPF/PGW-U 535 and/or one or more other devices or networks. Further, RAN 510 may receive signaling traffic, control plane traffic, etc. from UE 101 via the air interface, and may communicate such signaling traffic, control plane traffic, etc. to AMF 515 and/or one or more other devices or networks. Additionally, RAN 510 may receive traffic intended for UE 101 (e.g., from UPF/PGW-U 535, AMF 515, and/or one or more other devices or networks) and may communicate the traffic to UE 101 via the air interface.

RAN 512 may be, or may include, an LTE RAN that implements an LTE RAT and that includes one or more base stations (e.g., one or more eNBs 513), via which UE 101 may communicate with one or more other elements of environment 500. UE 101 may communicate with RAN 512 via an air interface (e.g., as provided by eNB 513). For instance, RAN 512 may receive traffic (e.g., user plane traffic such as voice call traffic, data traffic, messaging traffic, signaling traffic, etc.) from UE 101 via the air interface, and may communicate the traffic to UPF/PGW-U 535 (e.g., via SGW 517) and/or one or more other devices or networks. Further, RAN 512 may receive signaling traffic, control plane traffic, etc. from UE 101 via the air interface, and may communicate such signaling traffic, control plane traffic, etc. to MME 516 and/or one or more other devices or networks. Additionally, RAN 512 may receive traffic intended for UE 101 (e.g., from UPF/PGW-U 535, MME 516, SGW 517, and/or one or more other devices or networks) and may communicate the traffic to UE 101 via the air interface.

One or more RANs of environment 500 (e.g., RAN 510 and/or RAN 512) may include, may implement, and/or may otherwise be communicatively coupled to one or more edge computing devices, such as one or more Multi-Access/Mobile Edge Computing (“MEC”) devices (referred to sometimes herein simply as a “MECs”) 514. MECs 514 may be co-located with wireless network infrastructure equipment of RANs 510 and/or 512 (e.g., one or more gNBs 511 and/or one or more eNBs 513, respectively). Additionally, or alternatively, MECs 514 may otherwise be associated with geographical regions (e.g., coverage areas) of wireless network infrastructure equipment of RANs 510 and/or 512. In some embodiments, one or more MECs 514 may be implemented by the same set of hardware resources, the same set of devices, etc. that implement wireless network infrastructure equipment of RANs 510 and/or 512. In some embodiments, one or more MECs 514 may be implemented by different hardware resources, a different set of devices, etc. from hardware resources or devices that implement wireless network infrastructure equipment of RANs 510 and/or 512. In some embodiments, MECs 514 may be communicatively coupled to wireless network infrastructure equipment of RANs 510 and/or 512 (e.g., via a high-speed and/or low-latency link such as a physical wired interface, a high-speed and/or low-latency wireless interface, or some other suitable communication pathway).

MECs 514 may include hardware resources (e.g., configurable or provisionable hardware resources) that may be configured to provide services and/or otherwise process traffic to and/or from UE 101, via RAN 510 and/or 512. For example, RAN 510 and/or 512 may route some traffic from UE 101 (e.g., traffic associated with one or more particular services, applications, application types, etc.) to a respective MEC 514 instead of to core network elements of 500 (e.g., UPF/PGW-U 535). MEC 514 may accordingly provide services to UE 101 by processing such traffic, performing one or more computations based on the received traffic, and providing traffic to UE 101 via RAN 510 and/or 512. MEC 514 may include, and/or may implement, some or all of the functionality described above with respect to UPF/PGW-U 535, AF 530, one or more application servers, and/or one or more other devices, systems, VNFs, CNFs, etc. In this manner, ultra-low latency services may be provided to UE 101, as traffic does not need to traverse links (e.g., backhaul links) between RAN 510 and/or 512 and the core network.

AMF 515 may include one or more devices, systems, VNFs, CNFs, etc., that perform operations to register UE 101 with the 5G network, to establish bearer channels associated with a session with UE 101, to hand off UE 101 from the 5G network to another network, to hand off UE 101 from the other network to the 5G network, manage mobility of UE 101 between RANs 510 and/or gNBs 511, and/or to perform other operations. In some embodiments, the 5G network may include multiple AMFs 515, which communicate with each other via the N14 interface (denoted in FIG. 5 by the line marked “N14” originating and terminating at AMF 515).

MME 516 may include one or more devices, systems, VNFs, CNFs, etc., that perform operations to register UE 101 with the EPC, to establish bearer channels associated with a session with UE 101, to hand off UE 101 from the EPC to another network, to hand off UE 101 from another network to the EPC, manage mobility of UE 101 between RANs 512 and/or eNBs 513, and/or to perform other operations.

SGW 517 may include one or more devices, systems, VNFs, CNFs, etc., that aggregate traffic received from one or more eNBs 513 and send the aggregated traffic to an external network or device via UPF/PGW-U 535. Additionally, SGW 517 may aggregate traffic received from one or more UPF/PGW-Us 535 and may send the aggregated traffic to one or more eNBs 513. SGW 517 may operate as an anchor for the user plane during inter-eNB handovers and as an anchor for mobility between different telecommunication networks or RANs (e.g., RANs 510 and 512).

SMF/PGW-C 520 may include one or more devices, systems, VNFs, CNFs, etc., that gather, process, store, and/or provide information in a manner described herein. SMF/PGW-C 520 may, for example, facilitate the establishment of communication sessions on behalf of UE 101. In some embodiments, the establishment of communications sessions may be performed in accordance with one or more policies provided by PCF/PCRF 525.

PCF/PCRF 525 may include one or more devices, systems, VNFs, CNFs, etc., that aggregate information to and from the 5G network and/or other sources. PCF/PCRF 525 may receive information regarding policies and/or subscriptions from one or more sources, such as subscriber databases and/or from one or more users (such as, for example, an administrator associated with PCF/PCRF 525).

AF 530 may include one or more devices, systems, VNFs, CNFs, etc., that receive, store, and/or provide information that may be used in determining parameters (e.g., quality of service parameters, charging parameters, or the like) for certain applications.

UPF/PGW-U 535 may include one or more devices, systems, VNFs, CNFs, etc., that receive, store, and/or provide data (e.g., user plane data). For example, UPF/PGW-U 535 may receive user plane data (e.g., voice call traffic, data traffic, etc.), destined for UE 101, from DN 550, and may forward the user plane data toward UE 101 (e.g., via RAN 510, SMF/PGW-C 520, and/or one or more other devices). In some embodiments, multiple instances of UPF/PGW-U 535 may be deployed (e.g., in different geographical locations), and the delivery of content to UE 101 may be coordinated via the N9 interface (e.g., as denoted in FIG. 5 by the line marked “N9” originating and terminating at UPF/PGW-U 535). Similarly, UPF/PGW-U 535 may receive traffic from UE 101 (e.g., via RAN 510, RAN 512, SMF/PGW-C 520, and/or one or more other devices), and may forward the traffic toward DN 550. In some embodiments, UPF/PGW-U 535 may communicate (e.g., via the N4 interface) with SMF/PGW-C 520, regarding user plane data processed by UPF/PGW-U 535.

UDM/HSS 540 and AUSF 545 may include one or more devices, systems, VNFs, CNFs, etc., that manage, update, and/or store, in one or more memory devices associated with AUSF 545 and/or UDM/HSS 540, profile information associated with a subscriber. In some embodiments, UDM/HSS 540 may include, may implement, may be communicatively coupled to, and/or may otherwise be associated with some other type of repository or database, such as a UDR. AUSF 545 and/or UDM/HSS 540 may perform authentication, authorization, and/or accounting operations associated with one or more UEs 101 and/or one or more communication sessions associated with one or more UEs 101.

DN 550 may include one or more wired and/or wireless networks. For example, DN 550 may include an Internet Protocol (“IP”)-based PDN, a wide area network (“WAN”) such as the Internet, a private enterprise network, and/or one or more other networks. UE 101 may communicate, through DN 550, with data servers, other UEs 101, and/or to other servers or applications that are coupled to DN 550. DN 550 may be connected to one or more other networks, such as a public switched telephone network (“PSTN”), a public land mobile network (“PLMN”), and/or another network. DN 550 may be connected to one or more devices, such as content providers, applications, web servers, and/or other devices, with which UE 101 may communicate.

External devices 554 may include one or more devices or systems that communicate with UE 101 via DN 550 and one or more elements of 500 (e.g., via UPF/PGW-U 535). In some embodiments, external devices 554 may include, may implement, and/or may otherwise be associated with TSCTSF 301, one or more time translators 303, and/or other devices or systems. External devices 554 may include, for example, one or more application servers, content provider systems, web servers, or the like. External devices 554 may, for example, implement “server-side” applications that communicate with “client-side” applications executed by UE 101. External devices 554 may provide services to UE 101 such as gaming services, videoconferencing services, messaging services, email services, web services, and/or other types of services.

In some embodiments, external devices 554 may communicate with one or more elements of environment 500 (e.g., core network elements) via NEF/SCEF 549. NEF/SCEF 549 include one or more devices, systems, VNFs, CNFs, etc. that provide access to information, APIs, and/or other operations or mechanisms of one or more core network elements to devices or systems that are external to the core network (e.g., to external device 554 via DN 550). NEF/SCEF 549 may maintain authorization and/or authentication information associated with such external devices or systems, such that NEF/SCEF 549 is able to provide information, that is authorized to be provided, to the external devices or systems. For example, a given external device 554 may request particular information associated with one or more core network elements. NEF/SCEF 549 may authenticate the request and/or otherwise verify that external device 554 is authorized to receive the information, and may request, obtain, or otherwise receive the information from the one or more core network elements. In some embodiments, NEF/SCEF 549 may include, may implement, may be implemented by, may be communicatively coupled to, and/or may otherwise be associated with a Security Edge Protection Proxy (“SEPP”), which may perform some or all of the functions discussed above. External device 554 may, in some situations, subscribe to particular types of requested information provided by the one or more core network elements, and the one or more core network elements may provide (e.g., “push”) the requested information to NEF/SCEF 549 (e.g., in a periodic or otherwise ongoing basis).

In some embodiments, external devices 554 may communicate with one or more elements of RAN 510 and/or 512 via an API or other suitable interface. For example, a given external device 554 may provide instructions, requests, etc. to RAN 510 and/or 512 to provide one or more services via one or more respective MECs 514. In some embodiments, such instructions, requests, etc. may include QoS parameters, Service Level Agreements (“SLAs”), etc. (e.g., maximum latency thresholds, minimum throughput thresholds, etc.) associated with the services.

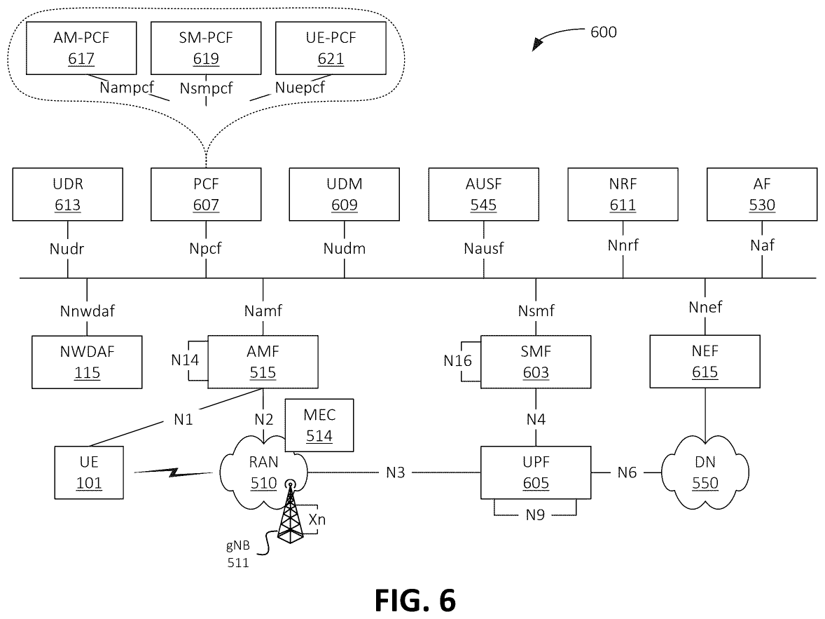

FIG. 6 illustrates another example environment 600, in which one or more embodiments may be implemented. In some embodiments, environment 600 may correspond to a 5G network, and/or may include elements of a 5G network. In some embodiments, environment 600 may correspond to a 5G SA architecture. In some embodiments, environment 600 may include a 5GC, in which 5GC network elements perform one or more operations described herein.

As shown, environment 600 may include UE 101, RAN 510 (which may include one or more gNBs 511 or other types of wireless network infrastructure) and various network functions, which may be implemented as VNFs, CNFs, etc. Such network functions may include AMF 515, SMF 603, UPF 605, PCF 607, UDM 609, AUSF 545, Network Repository Function (“NRF”) 611, AF 530, UDR 613, and NEF 615. Environment 600 may also include or may be communicatively coupled to one or more networks, such as DN 550.

The example shown in FIG. 6 illustrates one instance of each network component or function (e.g., one instance of SMF 603, UPF 605, PCF 607, UDM 609, AUSF 545, etc.). In practice, environment 600 may include multiple instances of such components or functions. For example, in some embodiments, environment 600 may include multiple “slices” of a core network, where each slice includes a discrete and/or logical set of network functions (e.g., one slice may include a first instance of SMF 603, PCF 607, UPF 605, etc., while another slice may include a second instance of SMF 603, PCF 607, UPF 605, etc.). Additionally, or alternatively, one or more of the network functions of environment 600 may implement multiple network slices. The different slices may provide differentiated levels of service, such as service in accordance with different QoS parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600.

Elements of environment 600 may interconnect with each other and/or other devices via wired connections, wireless connections, or a combination of wired and wireless connections. Examples of interfaces or communication pathways between the elements of environment 600, as shown in FIG. 6, may include interfaces shown in FIG. 6 and/or one or more interfaces not explicitly shown in FIG. 6. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 600 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 515), an Nudm interface (e.g., indicating communications to be routed to UDM 609), an Npcf interface, an Nupf interface, an Nnef interface, an Nsmf interface, an Nnrf interface, an Nudr interface, an Naf interface, and/or one or more other SBIs.

UPF 605 may include one or more devices, systems, VNFs, CNFs, etc., that receive, route, process, and/or forward traffic (e.g., user plane traffic). As discussed above, UPF 605 may communicate with UE 101 via one or more communication sessions, such as PDU sessions. Such PDU sessions may be associated with a particular network slice or other suitable QoS parameters, as noted above. UPF 605 may receive downlink user plane traffic (e.g., voice call traffic, data traffic, etc. destined for UE 101) from DN 550, and may forward the downlink user plane traffic toward UE 101 (e.g., via RAN 510). In some embodiments, multiple UPFs 605 may be deployed (e.g., in different geographical locations), and the delivery of content to UE 101 may be coordinated via the N9 interface. Similarly, UPF 605 may receive uplink traffic from UE 101 (e.g., via RAN 510), and may forward the traffic toward DN 550. In some embodiments, UPF 605 may implement, may be implemented by, may be communicatively coupled to, and/or may otherwise be associated with UPF/PGW-U 535. In some embodiments, UPF 605 may communicate (e.g., via the N4 interface) with SMF 603, regarding user plane data processed by UPF 605 (e.g., to provide analytics or reporting information, to receive policy and/or authorization information, etc.).

PCF 607 may include one or more devices, systems, VNFs, CNFs, etc., that aggregate, derive, generate, etc. policy information associated with the 5GC and/or UEs 101 that communicate via the 5GC and/or RAN 510. PCF 607 may receive information regarding policies and/or subscriptions from one or more sources, such as subscriber databases (e.g., UDM 609, UDR 613, etc.), and/or from one or more users such as, for example, an administrator associated with PCF 607. In some embodiments, the functionality of PCF 607 may be split into multiple network functions or subsystems, such as access and mobility PCF (“AM-PCF”) 617, session management PCF (“SM-PCF”) 619, UE PCF (“UE-PCF”) 621, and so on. Such different “split” PCFs may be associated with respective SBIs (e.g., AM-PCF 617 may be associated with an Nampcf SBI, SM-PCF 619 may be associated with an Nsmpcf SBI, UE-PCF 621 may be associated with an Nuepcf SBI, and so on) via which other network functions may communicate with the split PCFs. The split PCFs may maintain information regarding policies associated with different devices, systems, and/or network functions.

NRF 611 may include one or more devices, systems, VNFs, CNFs, etc. that maintain routing and/or network topology information associated with the 5GC. For example, NRF 611 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 613 may include one or more devices, systems, VNFs, CNFs, etc. that provide user and/or subscriber information, based on which PCF 607 and/or other elements of environment 600 may determine access policies, QoS policies, charging policies, or the like. In some embodiments, UDR 613 may receive such information from UDM 609 and/or one or more other sources.

NEF 615 include one or more devices, systems, VNFs, CNFs, etc. that provide access to information, APIs, and/or other operations or mechanisms of the 5GC to devices or systems that are external to the 5GC. NEF 615 may maintain authorization and/or authentication information associated with such external devices or systems, such that NEF 615 is able to provide information, that is authorized to be provided, to the external devices or systems. Such information may be received from other network functions of the 5GC (e.g., as authorized by an administrator or other suitable entity associated with the 5GC), such as SMF 603, UPF 605, a charging function (“CHF”) of the 5GC, and/or other suitable network function. NEF 615 may communicate with external devices or systems (e.g., external devices 554) via DN 550 and/or other suitable communication pathways.

While environment 600 is described in the context of a 5GC, as noted above, environment 600 may, in some embodiments, include or implement one or more other types of core networks. For example, in some embodiments, environment 600 may be or may include a converged packet core, in which one or more elements may perform some or all of the functionality of one or more 5GC network functions and/or one or more EPC network functions. For example, in some embodiments, AMF 515 may include, may implement, may be implemented by, and/or may otherwise be associated with MME 516; SMF 603 may include, may implement, may be implemented by, and/or may otherwise be associated with SGW 517; PCF 607 may include, may implement, may be implemented by, and/or may otherwise be associated with a PCRF (e.g., PCF/PCRF 525); NEF 615 may include, may implement, may be implemented by, and/or may otherwise be associated with a SCEF (e.g., NEF/SCEF 549); and so on.

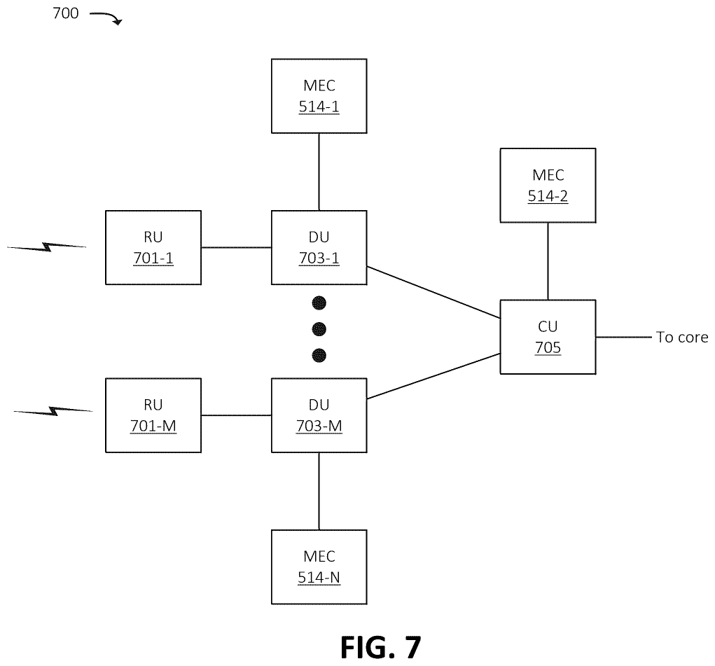

FIG. 7 illustrates an example RAN environment 700, which may be included in and/or implemented by one or more RANs (e.g., RAN 510 or some other RAN). In some embodiments, a particular RAN 510 may include one RAN environment 700. In some embodiments, a particular RAN 510 may include multiple RAN environments 700. In some embodiments, RAN environment 700 may correspond to a particular gNB 511 of RAN 510. In some embodiments, RAN environment 700 may correspond to multiple gNBs 511. In some embodiments, RAN environment 700 may correspond to one or more other types of base stations of one or more other types of RANs. As shown, RAN environment 700 may include Central Unit (“CU”) 705, one or more Distributed Units (“DUs”) 703-1 through 703-M (referred to individually as “DU 703,” or collectively as “DUs 703”), and one or more Radio Units (“RUs”) 701-1 through 701-M (referred to individually as “RU 701,” or collectively as “RUs 701”).

CU 705 may communicate with a core of a wireless network (e.g., may communicate with one or more of the devices or systems described above with respect to FIG. 6, such as AMF 515 and/or UPF 605) and/or some other device or system such as MEC 514. In the uplink direction (e.g., for traffic from UEs 101 to a core network), CU 705 may aggregate traffic from DUs 703, and forward the aggregated traffic to the core network. In some embodiments, CU 705 may receive traffic according to a given protocol (e.g., Radio Link Control (“RLC”) traffic) from DUs 703, and may perform higher-layer processing (e.g., may aggregate/process RLC packets and generate Packet Data Convergence Protocol (“PDCP”) packets based on the RLC packets) on the traffic received from DUs 703.

CU 705 may receive downlink traffic (e.g., traffic from the core network, traffic from a given MEC 514, etc.) for a particular UE 101, and may determine which DU(s) 703 should receive the downlink traffic. DU 703 may include one or more devices that transmit traffic between a core network (e.g., via CU 705) and UE 101 (e.g., via a respective RU 701). DU 703 may, for example, receive traffic from RU 701 at a first layer (e.g., physical (“PHY”) layer traffic, or lower PHY layer traffic), and may process/aggregate the traffic to a second layer (e.g., upper PHY and/or RLC). DU 703 may receive traffic from CU 705 at the second layer, may process the traffic to the first layer, and provide the processed traffic to a respective RU 701 for transmission to UE 101.

RU 701 may include hardware circuitry (e.g., one or more RF transceivers, antennas, radios, and/or other suitable hardware) to communicate wirelessly (e.g., via an RF interface) with one or more UEs 101, one or more other DUs 703 (e.g., via RUs 701 associated with DUs 703), and/or any other suitable type of device. In the uplink direction, RU 701 may receive traffic from UE 101 and/or another DU 703 via the RF interface and may provide the traffic to DU 703. In the downlink direction, RU 701 may receive traffic from DU 703, and may provide the traffic to UE 101 and/or another DU 703.

One or more elements of RAN environment 700 may, in some embodiments, be communicatively coupled to one or more MECs 514. For example, DU 703-1 may be communicatively coupled to MEC 514-1, DU 703-M may be communicatively coupled to MEC 514-N, CU 705 may be communicatively coupled to MEC 514-2, and so on. MECs 514 may include hardware resources (e.g., configurable or provisionable hardware resources) that may be configured to provide services and/or otherwise process traffic to and/or from UE 101, via a respective RU 701.

For example, DU 703-1 may route some traffic, from UE 101, to MEC 514-1 instead of to a core network via CU 705. MEC 514-1 may process the traffic, perform one or more computations based on the received traffic, and may provide traffic to UE 101 via RU 701-1. As discussed above, MEC 514 may include, and/or may implement, some or all of the functionality described above with respect to UPF 605, AF 530, and/or one or more other devices, systems, VNFs, CNFs, etc. In this manner, ultra-low latency services may be provided to UE 101, as traffic does not need to traverse DU 703, CU 705, links between DU 703 and CU 705, and an intervening backhaul network between RAN environment 700 and the core network.

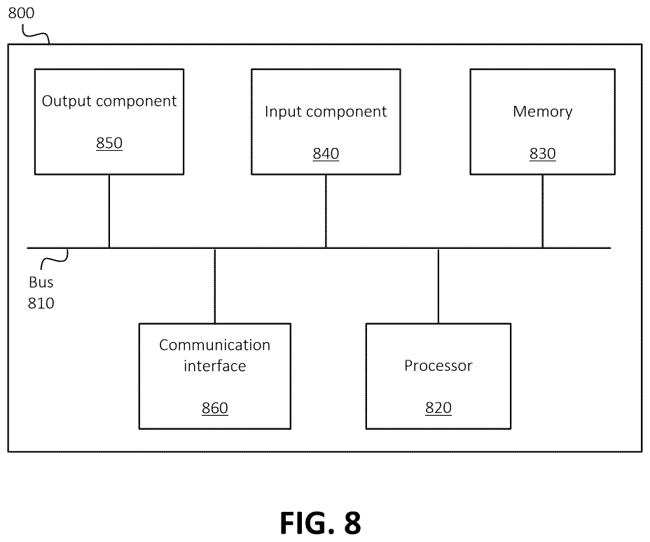

FIG. 8 illustrates example components of device 800. One or more of the devices described above may include one or more devices 800. Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, a set of provisioned hardware resources of a cloud computing system, or other suitable type of hardware that interprets and/or executes instructions (e.g., processor-executable instructions). In some embodiments, processor 820 may be or may include one or more hardware processors. Memory 830 may include any type of dynamic storage device that may store information and instructions for execution by processor 820, and/or any type of non-volatile storage device that may store information for use by processor 820.

Input component 840 may include a mechanism that permits an operator to input information to device 800 and/or other receives or detects input from a source external to input component 840, such as a touchpad, a touchscreen, a keyboard, a keypad, a button, a switch, a microphone or other audio input component, etc. In some embodiments, input component 840 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 850 may include a mechanism that outputs information to the operator, such as a display, a speaker, one or more light emitting diodes (“LEDs”), etc.

Communication interface 860 may include any transceiver-like mechanism that enables device 800 to communicate with other devices and/or systems (e.g., via RAN 510, RAN 512, DN 550, etc.). For example, communication interface 860 may include an Ethernet interface, an optical interface, a coaxial interface, or the like. Communication interface 860 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 800 may include more than one communication interface 860. For instance, device 800 may include an optical interface, a wireless interface, an Ethernet interface, and/or one or more other interfaces.

Device 800 may perform certain operations relating to one or more processes described above. Device 800 may perform these operations in response to processor 820 executing instructions, such as software instructions, processor-executable instructions, etc. stored in a computer-readable medium, such as memory 830. A computer-readable medium may be defined as a non-transitory memory device. A memory device may include space within a single physical memory device or spread across multiple physical memory devices. The instructions may be read into memory 830 from another computer-readable medium or from another device. The instructions stored in memory 830 may be processor-executable instructions that cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1, 2A, 2B, and 3-5), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
determine that a particular communication session, between a User Equipment (“UE”) and a wireless network, is associated with a set of time-sensitive communication policies;
output a first indication, to one or more Network Functions (“NFs”) of the wireless network with which the particular communication session is associated, that the particular communication session is associated with the set of time-sensitive communication policies;
output a second indication, to one or more routing devices via which the one or more NFs communicate, that the particular communication session is associated with the set of time-sensitive communication policies;
receive, from the one or more NFs of the wireless network, a first set of Key Performance Indicators (“KPIs”) associated with the time-sensitive communication session;
receive, from the routing devices, a second set of KPIs associated with the time-sensitive communication session; and
output the first and second sets of KPIs to an analytics element of the wireless network, wherein the analytics element aggregates the first and second sets of KPIs.

2. The device of claim 1, wherein the analytics element includes a Network Data Analytics Function (“NWDAF”) of the wireless network.

3. The device of claim 1, wherein the set of time-sensitive communication policies include a maximum latency threshold.

4. The device of claim 1, wherein outputting the first indication to the one or more NFs of the wireless network includes outputting the first indication to the one or more NFs via at least one of:
a Network Exposure Function (“NEF”), or
a Service Capability Exposure Function (“SCEF”).

5. The device of claim 1, wherein outputting the second indication to the one or more routing devices of the network includes outputting the second indication to the one or more routing devices via a Centralized Network Configuration (“CNC”).

6. The device of claim 1, wherein outputting the first and second sets of KPIs to the analytics element of the wireless network includes outputting the first and second sets of KPIs by a Centralized User Configuration (“CUC”).

7. The device of claim 1, wherein the analytics element of the wireless network modifies one or more artificial intelligence/machine learning (“AI/ML”) models based on the first and second sets of KPIs, and modifies a configuration of the one or more network devices or the one or more routing devices based on the modified one or more AI/ML models.

8. A non-transitory computer-readable medium, storing a plurality of processor-executable instructions to:
determine that a particular communication session, between a User Equipment (“UE”) and a wireless network, is associated with a set of time-sensitive communication policies;
output a first indication, to one or more Network Functions (“NFs”) of the wireless network with which the particular communication session is associated, that the particular communication session is associated with the set of time-sensitive communication policies;
output a second indication, to one or more routing devices via which the one or more NFs communicate, that the particular communication session is associated with the set of time-sensitive communication policies;
receive, from the one or more NFs of the wireless network, a first set of Key Performance Indicators (“KPIs”) associated with the time-sensitive communication session;
receive, from the routing devices, a second set of KPIs associated with the time-sensitive communication session; and
output the first and second sets of KPIs to an analytics element of the wireless network, wherein the analytics element aggregates the first and second sets of KPIs.

9. The non-transitory computer-readable medium of claim 8, wherein the analytics element includes a Network Data Analytics Function (“NWDAF”) of the wireless network.

10. The non-transitory computer-readable medium of claim 8, wherein the set of time-sensitive communication policies include a maximum latency threshold.

11. The non-transitory computer-readable medium of claim 8, wherein outputting the first indication to the one or more NFs of the wireless network includes outputting the first indication to the one or more NFs via at least one of:
a Network Exposure Function (“NEF”), or
a Service Capability Exposure Function (“SCEF”).

12. The non-transitory computer-readable medium of claim 8, wherein outputting the second indication to the one or more routing devices of the network includes outputting the second indication to the one or more routing devices via a Centralized Network Configuration (“CNC”).

13. The non-transitory computer-readable medium of claim 8, wherein outputting the first and second sets of KPIs to the analytics element of the wireless network includes outputting the first and second sets of KPIs by a Centralized User Configuration (“CUC”).

14. The non-transitory computer-readable medium of claim 8, wherein the analytics element of the wireless network modifies one or more artificial intelligence/machine learning (“AI/ML”) models based on the first and second sets of KPIs, and modifies a configuration of the one or more network devices or the one or more routing devices based on the modified one or more AI/ML models.

15. A method, comprising:
determining that a particular communication session, between a User Equipment (“UE”) and a wireless network, is associated with a set of time-sensitive communication policies;
outputting a first indication, to one or more Network Functions (“NFs”) of the wireless network with which the particular communication session is associated, that the particular communication session is associated with the set of time-sensitive communication policies;
outputting a second indication, to one or more routing devices via which the one or more NFs communicate, that the particular communication session is associated with the set of time-sensitive communication policies;
receiving, from the one or more NFs of the wireless network, a first set of Key Performance Indicators (“KPIs”) associated with the time-sensitive communication session;
receiving, from the routing devices, a second set of KPIs associated with the time-sensitive communication session; and
outputting the first and second sets of KPIs to an analytics element of the wireless network, wherein the analytics element aggregates the first and second sets of KPIs.

16. The method of claim 15, wherein the analytics element includes a Network Data Analytics Function (“NWDAF”) of the wireless network.

17. The method of claim 15, wherein outputting the first indication to the one or more NFs of the wireless network includes outputting the first indication to the one or more NFs via at least one of:
a Network Exposure Function (“NEF”), or
a Service Capability Exposure Function (“SCEF”).

18. The method of claim 15, wherein outputting the second indication to the one or more routing devices of the network includes outputting the second indication to the one or more routing devices via a Centralized Network Configuration (“CNC”).

19. The method of claim 15, wherein outputting the first and second sets of KPIs to the analytics element of the wireless network includes outputting the first and second sets of KPIs by a Centralized User Configuration (“CUC”).

20. The method of claim 15, wherein the analytics element of the wireless network modifies one or more artificial intelligence/machine learning (“AI/ML”) models based on the first and second sets of KPIs, and modifies a configuration of the one or more network devices or the one or more routing devices based on the modified one or more AI/ML models.
